(19) United States
(12) Patent Application Publication
(10) Pub. No.: US 2008/0165541 A1
(43) Pub. Date: Jul. 10, 2008

(54) ILLUMINATION APPARATUS AND CONDENSING PLATE THEREOF

(75) Inventors: Yen-Chun Chou, Taipei City (TW); Ching-Chung Chen, Taipei Hsien (TW)

Correspondence Address: BIRCH STEWART KOLASCH & BIRCH, PO BOX 747, FALLS CHURCH, VA, 22040-0747, US

(73) Assignee: PRODISC TECHNOLOGY INC., Taipei Hsien (TW)

(21) Appl. No.: 11/971,092

(22) Filed: Jan. 8, 2008

(30) Foreign Application Priority Data
Jan. 10, 2007 (TW) 096100990
Jan. 19, 2007 (CN) 200710000770.6

(51) Int. Cl. F21V 13/02; G02B 3/00; G02B 3/08

(52) U.S. Cl. 362/311; 359/811; 359/743

(57) ABSTRACT

An illumination apparatus includes a lampshade, a light source module and a condensing plate. The light source module is disposed in the lampshade, and has a light-emitting diode (LED) device and a circuit board. The LED device is disposed on the circuit board. The condensing plate is disposed in the lampshade and disposed over the LED device. The condensing plate has a condensing element disposed corresponding to the LED device.

### CROSS REFERENCE TO RELATED APPLICATIONS

This Non-provisional application claims priority under 35 U.S.C. §119(a) on Patent Application No(s). 096100990 filed in Taiwan, Republic of China on Jan. 10, 2007, the entire contents of which are hereby incorporated by reference.

### BACKGROUND OF THE INVENTION

1. Field of Invention

The invention relates to an illumination apparatus and, in particular, to an illumination apparatus with a condensing plate.

2. Related Art

With the advance in technology, illumination apparatuses have become an indispensable part of daily life. Their applications range from indoor illumination lamps and hand torches to vehicle head lights and flash lights.

A conventional illumination apparatus 1, such as a desktop lamp, is shown in FIG. 1. The illumination apparatus 1 has a lampshade 11 and a light-emitting element 12. The light-emitting element 12 is a light tube disposed in the lampshade 11. In this case, the light is directly emitted from the light-emitting element 12 or indirectly by the reflection of the lampshade 11.

How to increase the brightness of the illumination apparatus 1 is an important issue in the design. Currently, the brightness can be increased by using brighter light-emitting elements 12 or increasing the number thereof. However, either way inevitably increases the cost of the illumination apparatus 1.

In addition to sufficient brightness, the design of the illumination apparatus 1 also has to consider the comfort of the user. When the user uses the illumination apparatus for reading, it may have glares at large angles. The scattered light may directly enter the user's eyes, resulting in user's fatigue or discomfort.

Therefore, it is an important subject to provide an illumination apparatus that has the advantages of high brightness and comfortable visual experience.

### SUMMARY OF TUE INVENTION

In view of the foregoing, the invention is to provide an illumination apparatus and the condensing plate thereof that have the advantages of high brightness and comfortable visual experience.

To achieve the above, an illumination apparatus of the invention includes a lampshade, a light source module, and a condensing plate. The light source module is disposed in the lampshade and has a light-emitting diode (LED) device and a circuit board. The LED device is disposed on the circuit board. The condensing plate is disposed in the lampshade and over the LED device. The condensing plate has a condensing element disposed corresponding to the LED device.

To achieve the above, the invention also discloses a condensing plate. The condensing plate includes a condensing element having a concave part disposed on a light-inputting surface of the condensing plate.

As mentioned above, the illumination apparatus of the invention uses the condensing plate to converge light emitted by the LED device. Therefore, the brightness of the illumination apparatus can be increased and the glares can be avoided. Moreover, the illumination apparatus can be disposed with a diffusing plate to render the emitted light more uniform in brightness. Such a goal can be achieved by using a Fresnel pattern plate, and thus the user can have a more comfortable visual experience.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view of a conventional illumination apparatus;

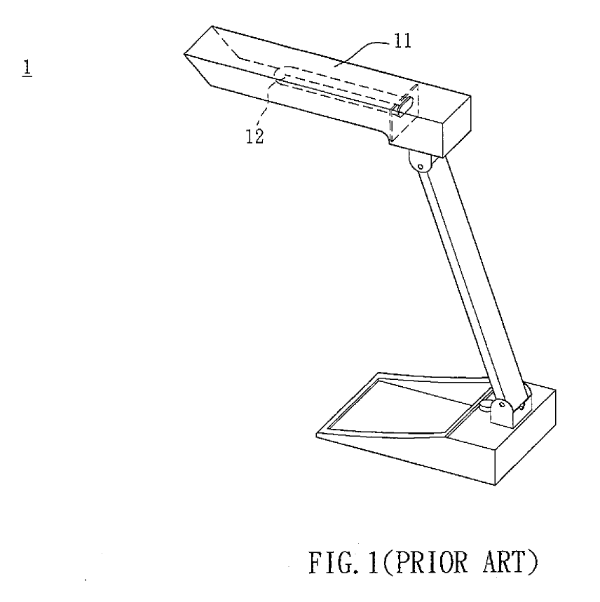

FIG. 2 is a schematic view of the illumination apparatus according to a first embodiment of the invention;

FIG. 3 is a schematic view of the illumination apparatus according to a first embodiment of the invention, showing an example of the condensing element;

FIG. 4 is a schematic view of the illumination apparatus according to a first embodiment of the invention, showing another example of the condensing element;

FIG. 5 is a schematic view of the illumination apparatus according to a second embodiment of the invention;

FIG. 6 shows the relations between brightness and viewing angle of the illumination apparatus of the invention; and

FIG. 7 is a schematic view of the condensing plate according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

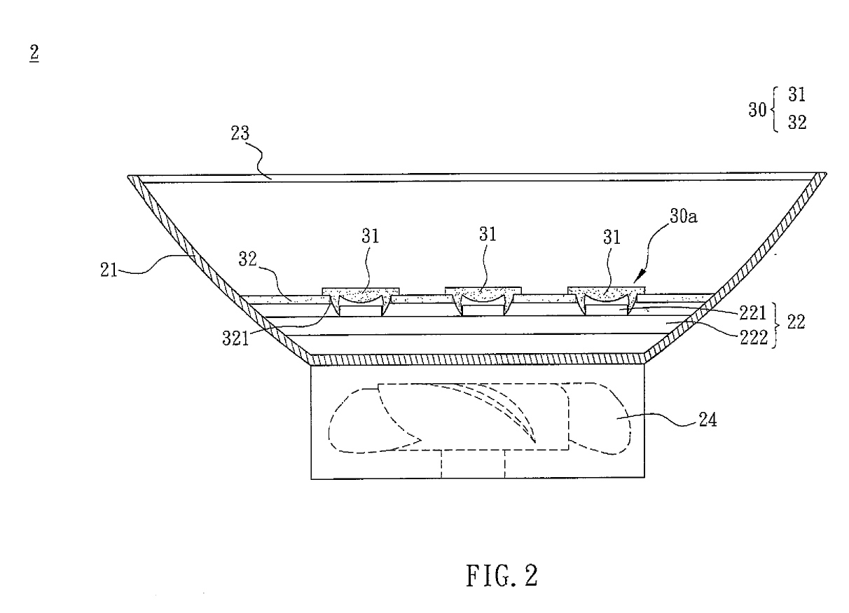

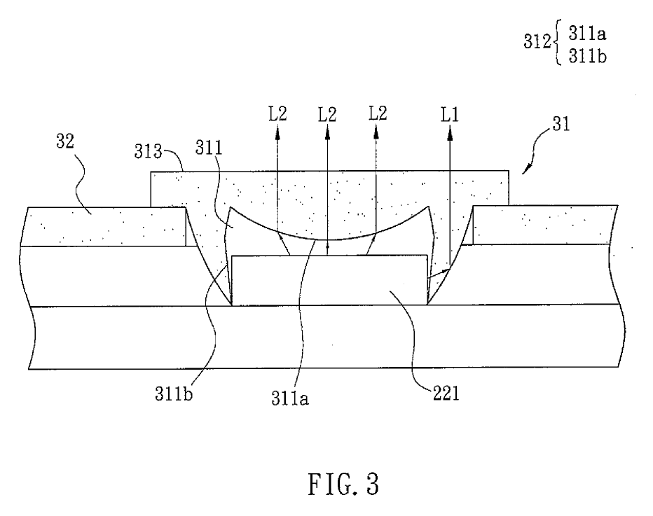

FIGS. 2 and 3 are schematic view of an illumination apparatus 2 according to a first embodiment of the invention. As shown in FIGS. 2 and 3, the illumination apparatus 2 includes a lampshade 21, a light source module 22, and a condensing plate 30. Applications of the illumination apparatus 2 include indoor illumination lamps, hand torches, vehicle head lights, flash lights, etc. In this embodiment, a desktop lamp is used as an example for the illumination apparatus 2.

In this embodiment, the material of the lampshade 21 can be plastic or metal. The shape of the lampshade may vary according to the needs.

The light source module 22 is disposed in the lampshade 21, and has an LED device 221 and a circuit board 222. The LED device 221 is disposed on the circuit board 222. In this embodiment, the light source module 22 includes several LED devices 221. Of course, the number of LED devices 221 may vary according to the needs. The LED devices 221 are disposed in an approximately symmetric way. When an external power source (not shown) is electrically connected with the circuit board 222, the LED devices 221 can emit light.

The condensing plate 30 is disposed in the lampshade 21 and over the LED devices 221. The condensing plate 30 has a condensing element 31 disposed corresponding to the LED devices 221. In this embodiment, the condensing plate 30 has several condensing elements 31 disposed corresponding to the LED devices 221.

As shown in FIG. 2, the condensing plate 30 in this embodiment has a plate 32 with several through holes 321. The condensing elements 31 are disposed inside the through holes 321 in an embedding or gluing way. Of course, the condensing elements 31 can be integrally formed with the plate 32 as well.

As shown in FIG. 3, the condensing element 31 has a concave part 311. The LED devices 221 are disposed adjacent to the concave part 311. In addition, the condensing element 31 has a light-inputting surface 312 and a light-outputting surface 313. The light-inputting surface 312 consists of a bottom surface 311a of the concave part 311 and two sidewalls 311b. The light-outputting surface 313 is disposed opposite to the bottom surface 311a of the concave part 311.

In this embodiment, the bottom surface 311a of the condensing element 31 is a convex surface protruding toward the LED device 221. When the side light L1 emitted by the LED device 221 enters the condensing element 31 via the sidewalls 311b of the concave part 311, the condensing element 31 reflects the light beam L1 toward the light-outputting surface 313. When the light L2 emitted by the LED device 221 enters the condensing element 31 via the bottom surface 311a of the concave part 311, the bottom surface 311a, which is a convex surface, converges the light beam L2 so that the light beam L2 leaves via the light-outputting surface 313.

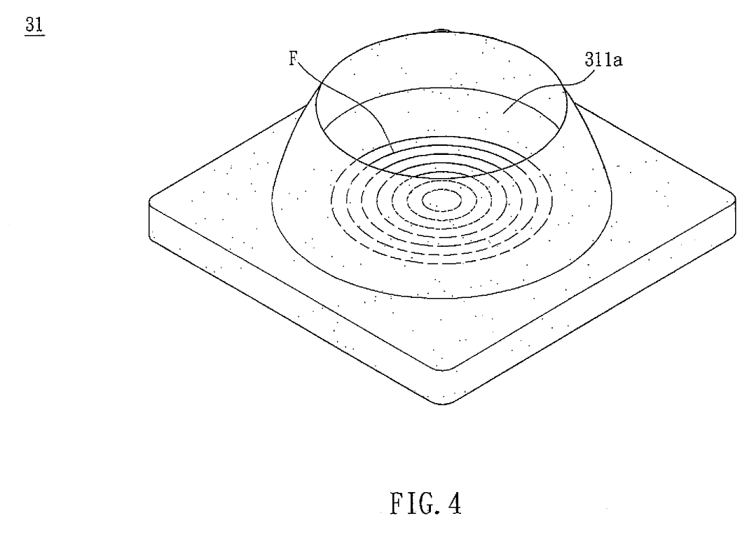

Of course, the bottom surface 311a of the concave part 311 in the condensing element 31 does not need to be a convex surface. As shown in FIG. 4, the bottom surface 311a of the concave part 311 in the condensing element 31 has a Fresnel pattern F for converging light and turning the incident light into a parallel light beam. The Fresnel pattern F can also be disposed on the light-outputting surface 313 of the condensing element 31.

With further reference to FIG. 2, the illumination apparatus 2 in this embodiment further includes a diffusing plate 23 disposed in the lampshade 21 and facing a light-outputting surface 30a of the condensing plate 30. In particular, the diffusing plate 23 has some diffusing particles, a whitening agent, some fluorescent powders, or a micro structure for diffusing light. Therefore, the diffusing plate 23 can soften the light emitted from the light-outputting surface 30a of the condensing plate 30, so that the user has a more comfortable visual feeling, without annoying glares.

In this embodiment, the illumination apparatus 2 further includes a heat-dissipating fan 24 connected with the lampshade 21. When the illumination apparatus 2 is turned on, the heat-dissipating fan 24 drives surrounding air to dissipate the heat produced by the illumination apparatus 2, elongating the lifetime thereof.

Using the above-mentioned structure, the condensing element 31 of the condensing plate 30 converges light emitted by the LED device 221 to increase the brightness thereof and prevent glares. In addition, the diffusing plate 23 diffuses light for a more comfortable visual experience of the user.

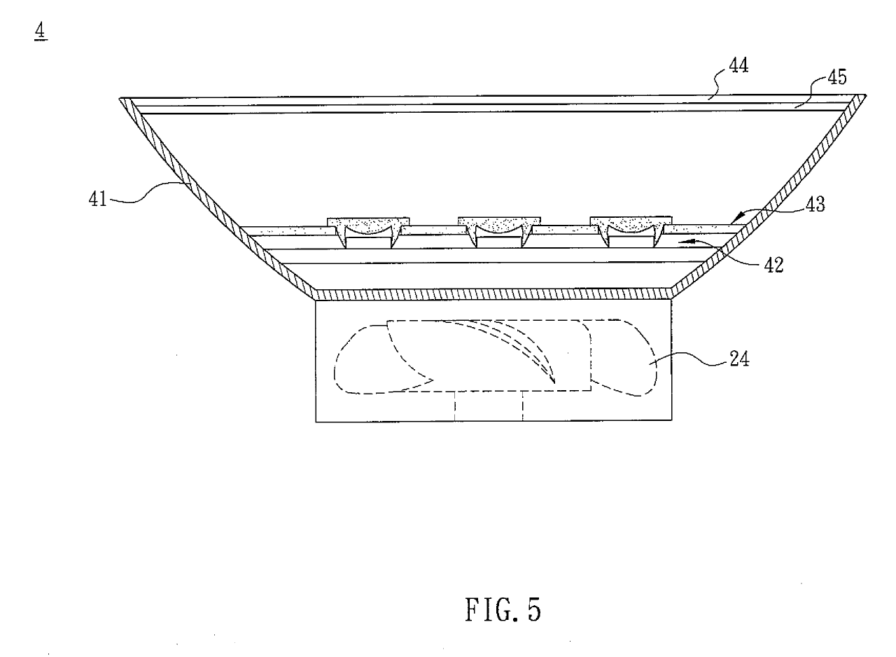

With reference to FIG. 5, an illumination apparatus 4 according to a second embodiment of the invention includes a lampshade 41, a light source module 42, a condensing plate 43, a diffusing plate 44 and a Fresnel pattern plate 45. The technical features and functions of the lampshade 41, the light source module 42, the condensing plate 43 and the diffusing plate 44 are the same as those of the lampshade 21, the light source module 22, the condensing plate 23 and the diffusing plate 24 in the first embodiment, so the detailed descriptions thereof are omitted.

In this embodiment, the Fresnel pattern plate 45 is disposed between the condensing plate 43 and the diffusing plate 44. Accordingly, the Fresnel pattern plate 45 renders the light beam emitted from the condensing plate 43 with uniform brightness.

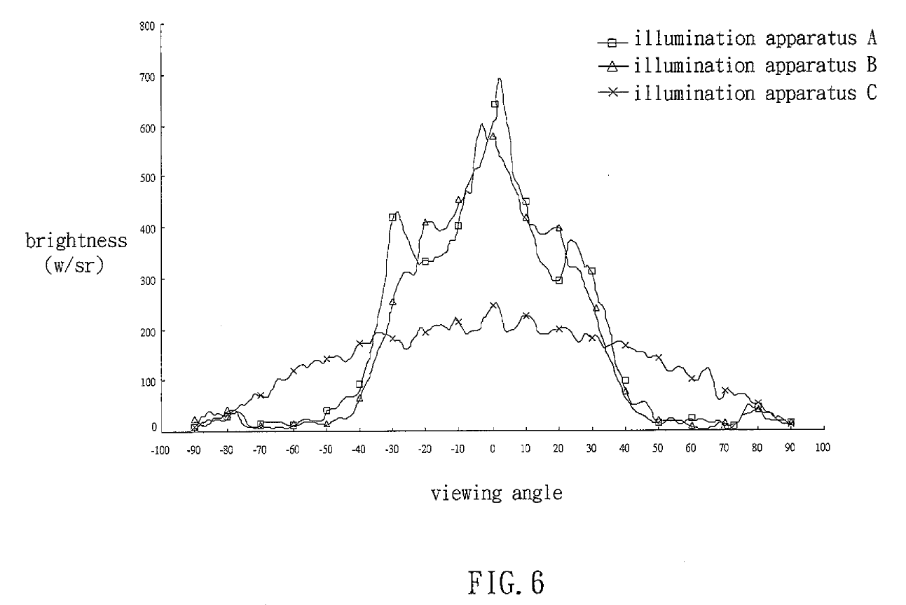

FIG. 6 shows the relations between brightness and viewing angle for the illumination apparatuses A, B, and C.

In this experiment, the illumination apparatuses A, B, and C are disposed respectively at a distance of 45 cm from a simulation desktop. The simulation desktop has an area of 30 cm×30 cm. The illumination apparatus A is the illumination apparatus 2 in the first embodiment. The illumination apparatus B is the illumination apparatus 4 in the second embodiment. The illumination apparatus C is one with only a lampshade and a light source module, but not the condensing plate, diffusing plate and Fresnel pattern plate.

As shown in FIG. 6, the illumination apparatuses A and B have larger brightness in the central area of the simulation desktop than the illumination apparatus. Therefore, the condensing plate indeed helps increasing the brightness in the central illumination area of the illumination apparatus.

Moreover, FIG. 6 shows that the use of a Fresnel pattern plate in the illumination apparatus B renders a smoother brightness curve. Therefore, the Fresnel pattern plate indeed achieves the effect of having uniform brightness in the emitted light.

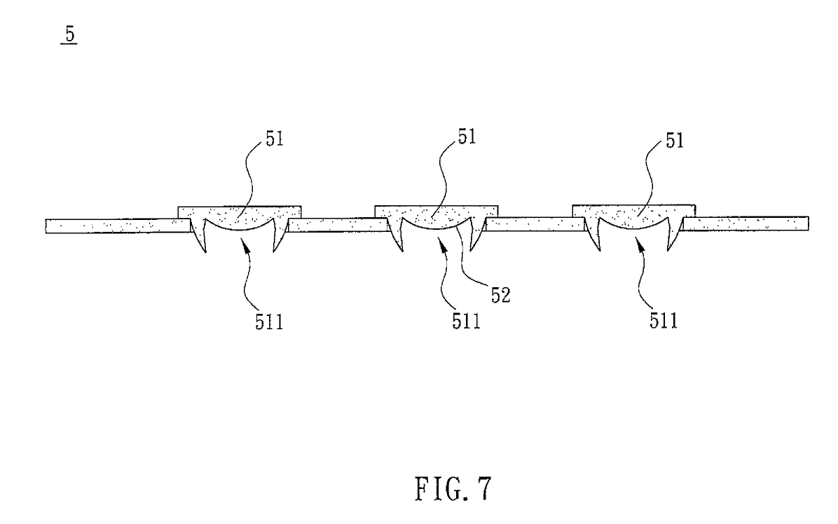

Finally, FIG. 7 shows a condensing plate 5 according to a preferred embodiment of the invention. The condensing plate 5 has a condensing element 51 having a concave part 511 and disposed at the light-inputting surface 52 of the condensing plate 5.

In this embodiment, the structure and functions of the condensing plate 5 are the same as those of the condensing plate 30 in the first embodiment, so the detailed descriptions thereof are omitted.

In summary, the illumination apparatus of the invention uses the condensing plate to converge light emitted by the LED device. Therefore, the brightness of the illumination apparatus can be increased and the glares can be avoided. Moreover, the illumination apparatus can be disposed with a diffusing plate to render the emitted light more uniform in brightness. Such a goal can be achieved by using a Fresnel pattern plate, and thus the user can have a more comfortable visual experience.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An illumination apparatus, comprising:
a lampshade;
a light source module, which is disposed in the lampshade and has a light-emitting diode (LED) device and a circuit board, wherein the LED device is disposed on the circuit board; and
a condensing plate, which is disposed in the lampshade and over the LED device and has a condensing element disposed corresponding to the LED device.

2. The illumination apparatus of claim 1, wherein the condensing plate has a plate with a through hole, and the condensing element is disposed inside the through hole.

3. The illumination apparatus of claim 1, wherein the condensing plate has a plate, and the condensing element and the plate are integrally formed.

4. The illumination apparatus of claim 1, wherein the condensing element has a concave part and the LED device is disposed adjacent to the concave part.

5. The illumination apparatus of claim 4, wherein a bottom surface of the concave part is a convex surface protruding toward the LED device.

6. The illumination apparatus of claim 4, wherein a bottom surface of the concave part has a Fresnel pattern.

7. The illumination apparatus of claim 4, wherein the condensing element has a light-outputting surface disposed opposite to a bottom surface of the concave part.

8. The illumination apparatus of claim 7, wherein the light-outputting surface has a Fresnel pattern.

9. The illumination apparatus of claim 1 further comprising:
a diffusing plate, which is disposed in the lampshade and facing a light-outputting surface of the condensing plate.

10. The illumination apparatus of claim 9 further comprising:
a Fresnel pattern plate, which is disposed between the diffusing plate and the condensing plate.

11. The illumination apparatus of claim 1 further comprising:
a heat-dissipating fan connected to the lampshade.

12. A condensing plate, comprising:
a condensing element having a concave part disposed on a light-inputting surface of the condensing plate.

13. The condensing plate of claim 12, wherein a LED device is disposed in the concave part.

14. The condensing plate of claim 12 further comprising:
a plate having a through hole, wherein the condensing element is disposed inside the through hole.

15. The condensing plate of claim 12 further comprising:
a plate, wherein the condensing element and the plate are integrally formed.

16. The condensing plate of claim 12, wherein a bottom surface of the concave part is a convex surface.

17. The condensing plate of claim 12, wherein a bottom surface of the concave part has a Fresnel pattern.

18. The condensing plate of claim 12, wherein the condensing element has a light-outputting surface disposed opposite to a bottom surface of the concave part.

19. The condensing plate of claim 18, wherein the light-outputting surface has a Fresnel pattern.
